(19) United States
(12) Patent Application Publication
(10) Pub. No.: US 2019/0179416 A1
(43) Pub. Date: Jun. 13, 2019

(54) INTERACTIVE VEHICLE SPEECH RECOGNITION AND CORRECTION SYSTEM

(71) Applicant: FORD GLOBAL TECHNOLOGIES, LLC, Dearborn, MI (US)

(72) Inventors: Sarra Awad Yako, Allen Park, MI (US); Theodore Borromeo, Detroit, MI (US)

(21) Appl. No.: 15/839,143

(22) Filed: Dec. 12, 2017

(51) Int. Cl. G06F 3/01; H04M 1/60; G10L 15/22; G10L 15/18; B60K 35/00

(52) U.S. Cl. CPC G06F 3/017; H04M 1/6075; H04W 4/04; G10L 15/1822; B60K 35/00; G10L 15/22

(57) ABSTRACT

A vehicle and method of operation includes a vehicle computing system having a hands free controller configured to respond to audio signals received from a voice processor, and to communicate an electronic sequence of words recognized from the signals. The controller and the voice processor also monitor for, detect, and receive an identified error in the recognized sequence of words. The hands free controller receives from the voice processor an audible correction to the identified error, and generates a corrected electronic sequence of the recognized words, according to the audible correction. The controller is further configured to generate a control command from the corrected sequence, which is communicated to a vehicle communication unit, to enable control of an internal and/or external system or device. The hands free controller, responsive to the corrected sequence, also stores a learned correction to an autocorrect repository that is used to generate correction recommendations.

### TECHNICAL FIELD

The disclosure relates to vehicle computing systems configured to recognize voice commands from audio, button press, and/or textual signals, and to enable automated, hands free and substantially hands free correction of individual misrecognized words, without the need repetition of the entire sequence of such voice commands.

### BACKGROUND

Vehicle manufacturers have developed various types of in-vehicle and/or on-board computer processing systems that include vehicle control, navigation, infotainment, and various other vehicle related systems, devices, and applications. Such systems, devices, and applications are often further enabled with voice recognition systems that enable operation of various vehicle communications devices and systems, as well as operation of external or off-board, third-party mobile and other devices, which may be connected to such vehicle systems. Such internal and on-board communications, infotainment, and navigation devices, applications, and systems, and such external, third-party, off-board applications, devices, and systems can include, for purposes of example, media players, mobile navigation devices, cellular, mobile, and satellite phones, personal digital assistants (PDAs), and many other devices, systems, and related applications.

When mistakes in audio and voice recognition occur, the known voice recognition capabilities require repetition of the entire voice command or sequence of commands. Such operations and uses have established a need for new and improved ways to recognize voice commands, and to enable new ways to efficiently make hands free and substantially hands free corrections to misrecognized, specific, and/or individual words of such voice commands or sequences of commands, without the need to repeat entire sequence of such commands.

### SUMMARY

Many types of personal, commercial, and industrial vehicles, including combustion engine and hybrid, plug-in hybrid, and battery electric vehicles, hereafter collectively referred to as “vehicles,” include several types of in-vehicle computing systems, devices, interfaces, networks, communications capabilities, and applications, which enable vehicle operation, as well as on-board and in-vehicle navigation, entertainment or infotainment, and related voice recognition and communications capabilities, as well as control and exchange of data between many types of internal, on-board, and external and off-board devices, applications, and systems.

The disclosure is directed to such vehicles that include a vehicle computing system and methods of operation that include, incorporate, and/or are modified as or with at least one and/or one or more hands free controller(s), which are configured to respond to audio signals received from a voice processor, and to generate a recognized word or words and/or a sequence of recognized words from the audio signals. The generated recognized words or sequence of words are communicated audibly by the voice processor or another audio capable device, and/or electronically as alphanumeric text to a display, such that errors to the recognized words or sequence of words can be interactively identified. The display may include one or more of an internal and on-board vehicle display and/or an external or off-board mobile or nomadic device sound processor and/or display located in a cabin of the vehicle.

Accordingly, the hands free controller(s) and/or voice processor are also configured to monitor for, detect, and receive at least one and/or one or more identified error(s) in the recognized words or sequence of words, as well as at least one hands-free correction or corrections to the identified error(s). Such correction or corrections may include, for purposes of example without limitation, an audible spoken word, an audible spelled word, an audibly or textually or button press selected recommended word, a textually spelled word from a touch screen or keyboard device, and/or other correction. In response, the controller(s) generate(s) a corrected electronic sequence of the recognized words, incorporating and according to the audible, textual, and/or button press correction(s). The hands free controller is further configured to generate a control command from the corrected sequence, which is communicated to a vehicle communication unit, to enable control of an internal and/or external system or device.

The hands free controller, responsive to the corrected sequence, also stores a learned correction and/or corrections to an autocorrect repository. The autocorrect repository of such accumulated learned corrections, is utilized to generate one or more of recognized words and/or correction recommendations for prospective identified errors. In variations of the disclosure, the hands free controller(s) is/are further modified to detect and receive the identified error with one or more of a spell command, and a recommend command that retrieves recommended corrections from the autocorrect repository. The spell command can be generated from an audible command detected by the controller(s) and/or voice processor, and may also be generated from a touch signal received from the one or more displays, as well as from a single button or switch of a vehicle instrument cluster or the mobile or nomadic devices.

In variations of the disclosure, the hands free controller is also modified to detect the identified error, in response to the recognized electronic sequence, from one or more of a signal from the voice processor, and a touch signal from the vehicle display, an off-board or external device display located in the cabin, and/or a button of a vehicle instrument cluster, which signals interactively identify the error displayed on at least one of the vehicle and external device displays. Further arrangements of the disclosure include the hands free controller also coupled to an image sensor, and further configured to detect the identified error from one or more gestures detected by the image sensor.

The hands free controller is also modified in other adaptations to respond to the corrected electronic sequence, and to generate and communicate the control command as one or more of phone call, text message, navigation, infotainment, and other similar commands, which are communicated to the vehicle communications unit and/or to the contemplated external mobile and nomadic devices located in the cabin. In configurations of the disclosure, the hands free controller is also modified to respond to the corrected electronic sequence, and to generate and communicate the control command as one or more of commands for: (a) vehicle lighting, seat adjustment, climate control, key on, key off, trunk latch open, door lock and unlock, window actuation, garage door actuator, autonomous parking, autonomous driving, parking garage and community entry authentication and gate systems, home automation and security, as well as (b) vehicle fuel, electrical, and propulsion system status inquiry(ies) and configuration commands, and (c) other vehicle control and inquiry commands, which are communicated to the vehicle communications unit.

This summary of the implementations and configurations of the vehicles and described components and systems introduces a selection of exemplary implementations, configurations, and arrangements, in a simplified and less technically detailed arrangement, and such are further described in more detail below in the detailed description in connection with the accompanying illustrations and drawings, and the claims that follow.

This summary is not intended to identify key features or essential features of the claimed technology, and it is not intended to be used as an aid in determining the scope of the claimed subject matter. The features, functions, capabilities, and advantages discussed here may be achieved independently in various example implementations or may be combined in yet other example implementations, as further described elsewhere herein, and which may also be understood by those skilled and knowledgeable in the relevant fields of technology, with reference to the following description and drawings.

### BRIEF DESCRIPTION OF THE DRAWINGS

FIG. 1 is an illustration of a vehicle and its systems, controllers, components, sensors, actuators, and methods of operation; and

FIG. 2 illustrates certain aspects of the disclosure depicted in FIG. 1, with components removed and rearranged for purposes of illustration.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As those of ordinary skill in the art should understand, various features, components, and processes illustrated and described with reference to any one of the figures may be combined with features, components, and processes illustrated in one or more other figures to enable embodiments that should be apparent to those skilled in the art, but which may not be explicitly illustrated or described. The combinations of features illustrated are representative embodiments for typical applications. Various combinations and modifications of the features consistent with the teachings of this disclosure, however, could be desired for particular applications or implementations, and should be readily within the knowledge, skill, and ability of those working in the relevant fields of technology.

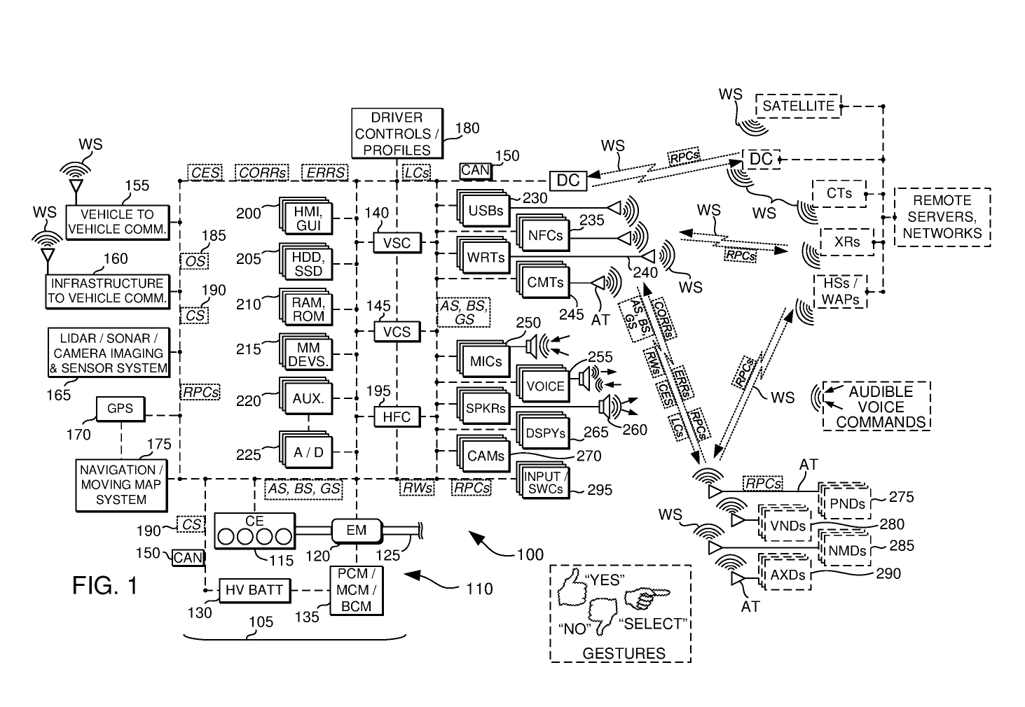

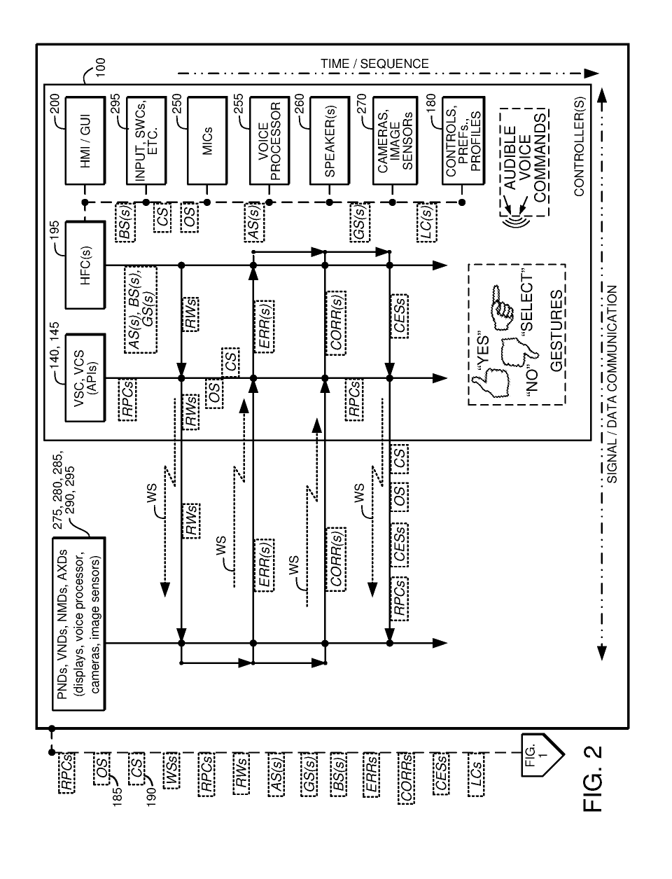

With reference now to the various figures and illustrations and to FIGS. 1 and 2, and specifically to FIG. 1, a schematic diagram of a conventional petrochemical-powered and/or hybrid electric vehicle 100 is shown, which vehicles may in further examples also include a battery electric vehicle, a plug-in hybrid electric vehicle, and combinations and modifications thereof, which are herein collectively referred to as a “vehicle” or “vehicles.” FIG. 1 illustrates representative relationships among components of vehicle 100. Physical placement and orientation, and functional and logical connections and interrelationships of the components within vehicle 100 may vary. Vehicle 100 includes a driveline 105 that has a powertrain 110, which includes one or more of a combustion engine (CE) 115 and an electric machine or electric motor/generator/starter (EM) 120, which generate power and torque to propel vehicle 100.

Engine or CE 115 is a gasoline, diesel, biofuel, natural gas, or alternative fuel powered combustion engine, which generates an output torque in addition to other forms of electrical, cooling, heating, vacuum, pressure, and hydraulic power by way of front end engine accessory devices. EM 120 may be any one of a plurality of types of electric machines, and for example may be a permanent magnet synchronous motor, electrical power generator, and engine starter 120. CE 115 and EM 120 are configured to propel vehicle 100 via a drive shaft 125 and in cooperation with various related components that may also further include a transmission, clutch(es), differentials, a braking system, wheels, and the like.

Powertrain 110 and/or driveline 105 further include one or more batteries 130. One or more such batteries can be a higher voltage, direct current battery or batteries 130 operating in ranges between about 48 to 600 volts, and sometimes between about 140 and 300 volts or more or less, which is/are used to store and supply power for EM 120 and during regenerative braking for capturing and storing energy, and for powering and storing energy from other vehicle components and accessories. Other batteries can be a low voltage, direct current battery(ies) 130 operating in the range of between about 6 and 24 volts or more or less, which is/are used to store and supply power for other vehicle components and accessories.

A battery or batteries 130, are respectively coupled to engine 115, EM 120, and vehicle 100, as depicted in FIG. 1, through various mechanical and electrical interfaces and vehicle controllers, as described elsewhere herein. High voltage EM battery 130 is also coupled to EM 120 by one or more of a power train control module (PCM), a motor control module (MCM), a battery control module (BCM), and/or power electronics 135, which are configured to convert and condition direct current (DC) power provided by high voltage (HV) battery 130 for EM 120.

PCM/MCM/BCM/power electronics 135 are also configured to condition, invert, and transform DC battery power into three phase alternating current (AC) as is typically required to power electric machine or EM 120. PCM/MCM/BCM 135/power electronics 135 is also configured to charge one or more batteries 130, with energy generated by EM 120 and/or front end accessory drive components, and to receive, store, and supply power from and to other vehicle components as needed.

With continued reference to FIG. 1, vehicle 100 further includes one or more controllers and computing modules and systems, in addition to PCM/MCM/BCM/power electronics 135, which enable a variety of vehicle capabilities. For example, vehicle 100 may incorporate a body control module (BCM) that is a stand-alone unit and that may be incorporated as part of a vehicle system controller (VSC) 140 and a vehicle computing system (VCS) and controller 145, which are in communication with PCM/MCM/BCM 135, and other controllers. For example, in some configurations for purposes of example but not limitation, VSC 140 and/or VCS 145 is and/or incorporates the SYNC™, APPLINK™, MyFord Touch™ and/or open source SmartDeviceLink and/or OpenXC onboard and offboard vehicle computing systems, in-vehicle connectivity, infotainment, and communications system and application programming interfaces (APIs), for communication and control of and/or with offboard and/or external devices.

For further examples, but not for purposes of limitation, at least one of and/or one or more of the controller(s) such as VSC 140 and VCS 145, may incorporate and further be and/or include one or more accessory protocol interface modules (APIMs) and/or an integral or separate head unit, which may be, include, and/or incorporate an information and entertainment system (also referred to as an infotainment system and/or an audio/visual control module or ACM/AVCM). Such modules include and/or may include a media player (MP3, Blu-Ray™, DVD, CD, cassette tape, etc.), stereo, FM/AM/satellite radio receiver, and the like, as well as a human machine interface (HMI) and/or display unit as described elsewhere herein. Such contemplated components and systems are available from various sources, and are for purposes of example manufactured by and/or available from the SmartDeviceLink Consortium, the OpenXC project, the Ford Motor Company, and others (See, for example, openXCplatform.com, SmartDeviceLink.com, www.ford.com, U.S. Pat. Nos. 9,080,668, 9,042,824, 9,092,309, 9,141,583, 9,141,583, 9,544,412, 9,680,934, and others).

In further examples, SmartLinkDevice (SDL), OpenXC, and SYNC™ AppLink™ are each examples that enable at least one of and/or one or more of the controller(s) such as VSC 140 and VCS 145, to communicate remote procedure calls (RPCs) utilizing application programming interfaces (APIs) that enable command and control of external or off-board mobile devices and applications, by utilizing the in-vehicle or on-board HMIs, such as GUI 200 and other input and output devices, which also include the hardware and software controls, buttons, and/or switches, as well as steering wheel controls and buttons (SWCs), instrument cluster and panel hardware and software buttons and switches, among other controls. Exemplary systems such as SDL, OpenXC, and/or AppLink™ enable functionality of the mobile device to be available and enabled utilizing the HMI of vehicle 100 such as SWCs and GUI 200, and also may include utilization of on-board or in-vehicle automated recognition and processing of voice commands.

Controller(s) of vehicle 100 such as VSC 140 and VCS 145, include and are coupled with one or more high speed, medium speed, and low speed vehicle networks, that include among others, a multiplexed, broadcast controller area network (CAN) 150, and a larger vehicle control system and other vehicle networks that may and/or may not require a host processor, controller, and/or server, and which may further include for additional examples, other micro-processor-based controllers as described elsewhere herein. CAN 150 may also include network controllers and routers, in addition to communications links between controllers, sensors, actuators, routers, in-vehicle systems and components, and off-board systems and components external to vehicle 100.

Such CANs 150 are known to those skilled in the technology and are described in more detail by various industry standards, which include for example, among others, Society of Automotive Engineers International™ (SAE) J1939, entitled “Serial Control and Communications Heavy Duty Vehicle Network”, and available from standards.sae.org, as well as, car informatics standards available from International Standards Organization (ISO) 11898, entitled “Road vehicles—Controller area network (CAN),” and ISO 11519, entitled “Road vehicles—Low-speed serial data communication,”, available from www.iso.org/ics/43.040.15/x/.

CAN 150 contemplates the vehicle 100 having one, two, three, or more such networks running at varying low, medium, and high speeds that for example nay range from about 50 kilobits per second (Kbps) to about 500 Kbps or higher. CAN 150 may also include, incorporate, and/or be coupled to and in communication with internal, onboard and external wired and wireless personal area networks (PANs), local area networks (LANs), wide area networks (WANs), among others and as described and contemplated elsewhere herein.

In further examples without limitation, VSC 140, VCS 145, and/or other controllers, devices, and processors, may include, be coupled to, be configured with, and/or cooperate with one or more integrally included, embedded, and/or independently arranged communications, navigation, and other systems, controllers, and/or sensors, such as a vehicle to vehicle communications system (V2V) 155, and roadway infrastructure to vehicle to infrastructure communication system (I2V, V2I) 160, a LIDAR/SONAR (light and/or sound detection and ranging) and/or video camera roadway proximity imaging and obstacle sensor system 165, a GPS or global positioning system 170, and a navigation and moving map display and sensor system 175, among others. VCS 145 can cooperate in parallel, in series, and distributively with VSC 140 and such steering wheel controls and buttons and other controllers, subsystems, and internal and external systems to manage and control vehicle 100, external devices, and such other controllers, and/or actuators, in response to sensor and communication signals, data, parameters, and other information identified, established by, communicated to, and received from these vehicle systems, controllers, and components, as well as other off-board systems that are external and/or remote to vehicle 100.

While illustrated here for purposes of example, as discrete, individual controllers, VSC 140 and VCS 145, and the other contemplated controllers, subsystems, and systems, may control, be controlled by, communicate signals to and from, and exchange data with other controllers, and other sensors, actuators, signals, and components, which are part of the larger vehicle and control systems, external control systems, and internal and external networks, components, subsystems, and systems. The capabilities and configurations described in connection with any specific micro-processor-based controller as contemplated herein may also be embodied in one or more other controllers and distributed across more than one controller such that multiple controllers can individually, collaboratively, in combination, and cooperatively enable any such capability and configuration. Accordingly, recitation of “a controller” or “the controller(s)” is intended to refer to such controllers, components, subsystems, and systems, both in the singular and plural connotations, and individually, collectively, and in various suitable cooperative and distributed combinations.

Further, communications over CAN 150 and other internal and external PANs, LANs, and/or WANs, are intended to include responding to, sharing, transmitting, and receiving of commands, signals, data, embedding data in signals, control logic, and information between controllers, and sensors, actuators, controls, and vehicle systems and components. The controllers communicate with one or more controller-based input/output (I/O) interfaces that may be implemented as single integrated interfaces enabling communication of raw data and signals, and/or signal conditioning, processing, and/or conversion, short-circuit protection, circuit isolation, and similar capabilities. Alternatively, one or more dedicated hardware or firmware devices, controllers, and systems on a chip may be used to precondition and preprocess particular signals during communications, and before and after such are communicated.

In further illustrations, VSC 140, VCS 145, CAN 150, and other controllers, may include one or more microprocessors or central processing units (CPU) in communication with various types of computer readable storage devices or media. Computer readable storage devices or media may include volatile and nonvolatile storage in read-only memory (ROM), random-access memory (RAM), and non-volatile or keep-alive memory (NVRAM or KAM). NVRAM or KAM is a persistent or non-volatile memory that may be used to store various commands, executable control logic and instructions and code, data, constants, parameters, and variables needed for operating the vehicle and systems, while the vehicle and systems and the controllers and CPUs are unpowered or powered off.

Computer-readable storage devices or media may be implemented using any of a number of known persistent and non-persistent memory devices such as PROMs (programmable read-only memory), EPROMs (electrically PROM), EEPROMs (electrically erasable PROM), hard disk drives (HDDs), solid state drives (SSDs), flash memory, or any other electric, magnetic, optical, or combination memory devices capable of storing and communicating data.

Each of such devices, components, processors, microprocessors, controllers, microcontrollers, memories, storage devices, and/or media may also further contain, include, and/or be embedded with one or more basic input and output systems (BIOSs), operating systems, application programming interfaces (APIs) having, enabling, and/or implementing remote procedure call (RPCs), and related firmware, microcode, software, logic instructions, commands, and the like, which enable programming, customization, coding, and configuration, and which may be embedded and/or contained in at least one of and/or distributed across one or more such devices, among other capabilities.

In this arrangement, VSC 140 and VCS 145 cooperatively manage and control the vehicle components and other controllers, sensors, and actuators, including for example without limitation, external and/off-board devices located in or near or proximate to a vehicle cabin, and/or various other components and devices. For example, controllers 140, 145 and others may establish bidirectional communications with such internal and external sources, and communicate control commands, logic, and instructions and code, data, information, and signals to and/or from engine 115, EM 120, batteries 130, PCM/MCM/BCM/power electronics 135, and other internal and external components, devices, subsystems, and systems. The controllers also may control and communicate with other vehicle components known to those skilled in the art, even though not shown in the figures.

The embodiments of vehicle 100 in FIG. 1 also depict exemplary sensors and actuators in communication with wired and/or wireless vehicle networks and CAN 150 (PANs, LANs) that can bidirectionally transmit and receive data, commands, and/or signals to and from VSC 140, VCS 145, and other controllers. Such control commands, logic, and instructions and code, data, information, signals, settings, and parameters, including driver preferred settings and preferences, may be captured and stored in, and communicated from a repository of driver controls, preferences, and profiles 180, as well as memory and data storage of the other controller(s).

As described and illustrated in the various figures, including FIGS. 1 and 2, the signals and data, including for example, commands, information, settings, parameters, control logic and executable instructions, and other signals and data, can also include other signals (OS) 185, and control or command signals (CS) 190 received from and sent to and between controllers and vehicle components and systems, either over wired and/or wireless data and signaling connections. OS 185, and CS 190, and other signals, related control logic and executable instructions, parameters, and data can and/or may be predicted, generated, established, received, communicated, to, from, and between any of the vehicle controllers, sensors, actuators, components, and internal, external, and remote systems.

Any and/or all of these signals can be raw analog or digital signals and data, or preconditioned, preprocessed, combination, and/or derivative data and signals generated in response to other signals, and may encode, embed, represent, and be represented by voltages, currents, capacitances, inductances, impedances, and digital data representations thereof, as well as digital information that encodes, embeds, and/or otherwise represents such signals, data, and analog, digital, and multimedia information.

The communication and operation of the described signals, commands, control instructions and logic, and data and information by the various contemplated controllers, sensors, actuators, and other vehicle components, may be represented schematically as shown in FIGS. 1 and 2, and by flow charts or similar diagrams as exemplified in the methods of the disclosure illustrated specifically in FIG. 2. Such flow charts and diagrams illustrate exemplary commands and control processes, control logic and instructions, and operation strategies, which may be implemented using one or more computing, communication, and processing techniques that can include real-time, event-driven, interrupt-driven, multi-tasking, multi-threading, and combinations thereof.

The steps and functions shown may be executed, communicated, and performed in the sequence depicted, and in parallel, in repetition, in modified sequences, and in some cases may be combined with other processes and/or omitted. The commands, control logic, and instructions may be executed in one or more of the described microprocessor-based controllers, in external controllers and systems, and may be embodied as primarily hardware, software, virtualized hardware, firmware, virtualized hardware/software/firmware, and combinations thereof.

FIG. 1 also schematically depicts for continuing illustration purposes but not for purposes of limitation, an example configuration and block topology for VCS 145 for vehicle 100 and its contemplated controllers, devices, components, subsystems, and/or systems. For example, the various controllers, such as for example VCS 145, include(s) and/or may include in some arrangements, at least one and/or one or more hands free controller(s) 195, HFC(s), human machine interfaces (HMIs)/graphical user interface(s) and visual display(s) (GUIs, HMIs) 200, and others which may be located in a cabin of vehicle 100.

HFC(s) 195 and HMIs/GUIs 200 may also be configured to detect audible voice commands, and be coupled and cooperate with automated voice processors and speech recognition and speech synthesis subsystems, as well as with additional hardware and software controls, buttons, and/or switches, which are incorporated, included, and/or displayed on, about, and/or as part of HMI/GUI 200 and associated and/or integrated instrument clusters and panels 200 of vehicle 100. Such configurations that incorporate HFCs 195 contemplate and enable audio, voice controlled hands free and mostly hands free operation of various vehicle components, systems, subsystems, and/or devices, utilizing voice recognition capabilities and/or single hardware and/or software button presses on instrument clusters and SWCs 295 that are located on and/or adjacent to a steering wheel of vehicle 100. In this way, a driver may interact audibly with voice commands, and by single button presses, with applications and systems of vehicle 100 and of external devices 275, 280, 285, 290, which may be connected to vehicle 100, without diverting attention and/or without having to move hands of a driver from a steering wheel during vehicle operation.

Such controls, buttons, and/or switches and instrument clusters and panels may be integrated with HMIs/GUIs 200, as well as with other vehicle devices and systems that may include, for further examples and illustrations, a steering wheel and related components, vehicle dashboard panels and instrument displays and clusters 200, and the like. For added purposes of example without limitation, VCS 145 may include and/or incorporate persistent memory and/or storage HDDs, SSDs, ROMs 205, and non-persistent or persistent RAM/NVRAM/EPROM 210, and/or similarly configured persistent and non-persistent memory and storage components.

VCS 145, HFC(s) 195, and/or other controller(s), in illustrative but non-limiting examples, also include, incorporate, and/or are coupled to one or more vehicle-based bidirectional data input, output, and/or communications and related devices and components, which enable communication with users, drivers, and occupants of vehicle 100, as well as with external proximate and remote devices, networks (CAN 150, PANs, LANs, WANs), and/or systems. The phrases “vehicle-based” and “onboard” refer to devices, subsystems, systems, and components integrated into, incorporated about, coupled to, and/or carried within vehicle 100 and its various controllers, subsystems, systems, devices, and/or components. The phrases and words “offboard” and “external” refer to mobile, nomadic, and/or personal devices that may be located in and/or near or proximate to the vehicle cabin, and which are capable of communication and connection with the various vehicle computing and communication devices, systems, subsystems, and related components.

For additional examples, VCS 145, HFC(s) 195, GUIs 200, and other controllers of vehicle 100, may include, incorporate, be paired to, communicate with, connect to, synchronize with, and/or be coupled to onboard vehicle-based multimedia devices 215, auxiliary input(s) 220 and analog/digital (A/D) circuits 225, universal serial bus port(s) (USBs) 230, near field communication transceivers (NFCs) 235 such as “Bluetooth” devices, wireless routers and/or transceivers (WRTs) 240 that enable wireless personal and local area networks (WPANs, WLANs) or “WiFi” IEEE 802.11 and 803.11 communications standards (Institute of Electrical and Electronics Engineers), and/or analog and digital cellular network modems and transceivers (CMTs) 245 utilizing voice/audio and data encoding and technologies that include for example, those managed by the International Telecommunications Union (ITU) as International Mobile Telecommunications (IMT) standards, which are often referred to as global system for mobile communications (GSM), enhanced data rates for GSM evolution (EDGE), universal mobile telecommunications system (UMTS), 2G, 3G, 4G, 5G, long-term evolution (LTE), code, space, frequency, polarization, and/or time division multiple access encoding (CDMA, SDMA, FDMA, PDMA, TDMA), and similar and related protocols, encodings, technologies, networks, and services.

These contemplated onboard devices and components, among others, are configured to enable bidirectional wired and wireless communications between components and systems of vehicle 100, CAN 150, and other external devices and systems and PANs, LANs, and WANs. A/D circuit(s) 225 is/are configured to enable analog-to-digital and digital-to-analog signal conversions. HFC(s) 195, auxiliary inputs 220 and USBs 230, among other devices and components, may also enable in some configurations wired and wireless Ethernet, onboard diagnostic (OBD), free-space optical communication such as Infrared (IR) Data Association (IrDA) and non-standardized consumer IR data communication protocols, IEEE 1394 (FireWire™ (Apple Corp.), LINK™ (Sony), Lynx™ (Texas Instruments)), EIA (Electronics Industry Association) serial protocols, IEEE 1284 (Centronics Port protocols), S/PDIF (Sony/Philips Digital Interconnect Format), and USB-IF (USB Implementers Forum), and similar data protocols, signaling, and communications capabilities.

HFC(s) 195, auxiliary inputs 220 and A/D circuits 225, USBs 230, NFCs 235, WRTs 240, and/or CMTs 245, is/are coupled with, integrated with, and/or may incorporate integral amplifier, signal conversion, and/or signal modulation circuits, which are configured to attenuate, convert, amplify, and/or communicate signals, and which are further configured to receive various analog and/or digital input signals, data, and/or information that is processed and adjusted and communicated to and between the various wired and wireless networks and controllers.

Such wired and wireless contemplated networks and controllers include, for example but not limitation, CAN 150, VCS 145, and other controllers and networks of vehicle 100. HFC(s) 195, auxiliary inputs 220, A/D circuits 225, USBs 230, NFCs 235, WRTs 240, and/or CMTs 245, and related hardware, software, and/or circuitry are compatible and configured to receive, transmit, and/or communicate at least one of and/or one or more of a variety of wired and wireless signals, signaling, data communications, and/or data streams (WS), and data such as navigation, audio and/or visual, and/or multimedia signals, commands, control logic, instructions, information, software, programming, and similar and related data and forms of information.

Additionally, one or more input and output data communication, audio, and/or visual devices are contemplated to be integrated with, coupled to, and/or connectable to, HFC(s) 195, auxiliary inputs 220, A/D circuits 225, USBs 230, NFCs 235, WRTs 240, and/or CMTs 245, as well as to the other contemplated controller(s) and wired and wireless networks internal to vehicle 100, and in some circumstances external to vehicle 100. For example, the one or more input and output devices include onboard microphones 250, voice processors and processing and recognition devices and applications and subsystems 255, speaker(s) 260, additional display(s) 265, camera(s) 270, and similar offboard or external devices such as personal navigation devices (PNDs) 275, portable vehicle navigation devices (VNDs) 280, nomadic and mobile devices (NMDs) 285, and/or other portable auxiliary devices (AXDs) 290, among others, which each include at least one and/or one or more integrated signaling and communications units and antennas and/or transceivers (AT).

Such input and output devices are and/or may be selectable, connectable, synchronized with, paired to, coupled to, connected to, in communication with, and/or actuatable with an input selector 295. Input selector 295 may include, incorporate, and/or be integrated with and/or as part of HFC(s) 195, GUI and instrument clusters and panels 200, and the contemplated hardware and software SWCs, controls, buttons, and/or switches (also schematically represented by reference numeral 295) contemplated by the disclosure as generating and communicating actuation signals and being part of and utilized with the steering wheel and related components, and with the vehicle dashboard and instrument panels and clusters. Such HFC(s) 195, input selector, SWCs, controls, buttons, and/or switches 200, 295 may be hardware or software or combinations thereof and may be configurable utilizing one or more predetermined, default, and adjustable factory and/or driver controls, profiles, and/or preferences 180.

The contemplated HFC(s) 195, microphones 250, voice processor and processing and recognition devices and subsystems 255, speaker(s) 260, additional display(s) 265, camera(s) 270, PNDs 275, VNDs 280, NMDs 285, and/or other portable auxiliary devices AXDs 290, may also include for purposes of further example but not limitation, cell phones, mobile phones, smart phones, satellite phones and modems and communications devices, tablets, personal digital assistants, personal media players, key fob security and data storage devices, personal health devices, laptops, portable wireless cameras, headsets and headphones that may include microphones, wired and wireless microphones, portable NFC speakers and stereo devices and players, portable GPS and navigation devices, and similar devices and components that each may include integrated transceivers and antennas AT, wired and plugged connectors DC, and related components, for generating, communicating, and receiving wired and wireless multimedia and data communications signals WS.

Such contemplated controllers, and input, output, and/or communications devices, components, subsystems, and systems internal to and onboard vehicle 100 are and/or may be configured to bidirectionally communicate over wired and wireless data connections (DCs) and wired and wireless signals and signaling and data communications and streams WS, with external and offboard near and far nomadic, portable, and/or mobile devices, 275, 280, 285, 295, networks, and systems that may include, for example, hotspots and wireless access points (HS/WAPs), nano and micro and regular cellular access points and towers (CT), external routers (XRs), and related and accessible external, remote networks, systems, and servers.

With continuing reference to the various figures, including FIGS. 1 and 2, it may be understood by those with knowledge in the relevant fields of technology that the disclosure contemplates vehicle 100 to include at least one and/or one or more controller(s) such as VSC 140, VCS 145, HFC(s) 195, and others coupled with an in-vehicle or on-board transceiver AT, such as those described in connection with USBs 230, NFCs 235, WRTs 240, and/or CMTs 245. The controller(s) 140, 145, HFC(s) 195, and transceiver(s) AT are configured to detect and connect with WSs to nearby or proximate or far but in-range of WSs, third-party, off-board, external devices such as nomadic, portable, and/or mobile devices, 275, 280, 285, 295.

With continuing reference to FIG. 1, vehicles 100 and methods of operation include VSC 140, VCS 145, and other controller(s) configured as and/or coupled with at least one and/or one or more HFCs 195, modified to respond to audio signals AS(s), such as voice commands from a driver and/or passenger of vehicle 100, received from voice processor and/or processing and recognition system 255. Examples of such VCS 145, HFCs 195, and voice processor 255 are available as part of the SYNC system available from Ford Motor Company, and other similar systems described elsewhere herein. One or more of the controller(s), such as HFCs 195 and/or are further configured to generate a recognized word or words and/or a sequence of recognized words RW(s) from the audio signals AS(s). RWs may also be generated utilizing RPCs and APIs to command internal devices as well as external and/or offboard devices PNDs 275, VNDs 280, NMDs 285, AXDs 290, and others to audibly generate and generate and display alphanumeric text the RWs.

The generated recognized words or electronic sequence of words RW(s) are communicated to such controller(s) VCS 145, HFCs 195, and/or others, and are in turn communicated audibly by voice processor 255, another audio capable device such as speakers 260, external devices 275, 280, 285, 290, and/or electronically and visually as alphanumeric text to internal and/or external GUIs/HMIs 200 and displays 265, 275, 280, 285, 290.

The audible and/or alphanumeric communication of the generated RWs, enables errors to be interactively identified. For example, one or more of such controller(s) 145, HFCs 195, and/or voice processor 255, and others, are configured to utilize the audible and/or visually displayed RWs and to monitor for, detect, and receive at least one and/or one or more identified error(s) ERR(s) in the RWs, as well as an audible and/or textual correction or corrections CORR(s) to the identified error(s). The controller(s) such as VSC 140, VCS 145, HFCs 195, GUI/HMI 200, 215, SWCs 295, and/or voice processor 255, are further configured to receive one or more hands free audible and/or button press and/or touch signals and/or textual signals BS(s) that indicate, communicate, and/or establish an identified error or errors ERR(s) exist(s) in RWs.

In variations, the at least one and/or one or more controller(s) is/are modified to detect ERRs from one or more of an off-board or external device and/or device display 275, 280, 285, 290, 295, which may be located in and/or proximate to the cabin of vehicle 100. Still other modifications of the disclosure contemplate one or more of HFCs 195 and controller(s) and components 140, 145, 195, 200, 215, 255, 295, configured to recognize gestures of a driver and/or passenger of vehicle 100, and coupled to an image sensor such as internal camera and image sensor(s) 270, and/or to external cameras and images sensors of PNDs 275, VNDs 280, NMDs 285, AXDs 285, and others.

In these arrangements, at least one of such cameras and image sensors and HFCs 195 and controller(s) and components 140, 145, 195, 200, 215, 255, 270, 295, and/or PNDs 275, VNDs 280, NMDs 285, AXDs 285, are also configured to detect such gestures and to generate gesture signals GSs, which may represent predetermined recognized gestures for a “yes” response (such as a “thumbs up gesture), a “no” response (such as a thumbs down response), a “select” or “button press/touch” response (such as a finger point gesture in a direction related to and/or according to the displayed RWs or prompts), and/or other gestures. Utilizing GSs, the controller(s) detect ERRs from one or more of such gestures.

If an error in one or more RWs is identified, at least one of controller(s) and components 140, 145, 195, 200, 215, 255, 295, may audibly and/or visually recite and display and/or visually highlight each individual word in the RWs, one at a time, and briefly monitor for a signal (AS, GS, button press) that indicates an error and/or confirms accuracy. For example, while briefly monitoring, one or more of controller(s) and components 140, 145, 195, 200, 215, 255, 295, may audibly and/or visually recite a prompt such as “Correct?—yes or no.”

After which, controller(s) and components 140, 145, 195, 200, 215, 255, 295, detect a yes or no response, or silence, which may be assumed as a yes response, and generate a corresponding yes or no signal. At least one of controller(s) and components 140, 145, 195, 200, 215, 255, 295, may detect an audible “yes” response AS, or inaudible silence as a predetermined “yes,” and/or may also detect a gesture and/or button press response GS, BS from GUI/HMI 200 and/or SWCs 295 in response to the visual recitation of the “Correct? . . . ” prompt.

One or more of controller(s) and components 140, 145, 195, 200, 215, 255, 295, may then display the “Correct?—yes or no” phrase as touch screen software buttons, which may be actuated with an audible response AS, a gesture response GS, and/or single button press BS, to generate the yes or no signals AS, GS, BS. In other arrangements, at least one of controller(s) and components 140, 145, 195, 200, 215, 255, 295, may also be configured to enable the visually displayed RWs to be touch screen selectable as a software button press, to generate BS and identify the individual word error or errors. In other variations, in addition to and/or in combination with the detectable gestures, controller(s) and components 140, 145, 195, 200, 215, 255, 295, may be configured to have predetermined hardware or software buttons or switches, such as those contemplated for GUI/HMI 200 and/or SWCs of instrument clusters 295, to represent yes or no responses that generate BS in response to the button press or touch.

If silence or an audible and/or gesture “yes” AS, GS, and/or a “yes” button press signal BS are detected, one or more of controller(s) and components 140, 145, 195, 200, 215, 255, 295, move to the next word in the RWs, and recite the “Correct? . . . ” prompt or inquiry again and pause to detect a response. If an audible, gesture, and/or button press “no” response AS, BS, GS is detected, one of controller(s) and components 140, 145, 195, 200, 215, 255, 295, may then audibly and/or visually recite another prompt or inquiry, such as for example without limitation, “Spell or recommend a correction.” controller(s) and components 140, 145, 195, 200, 215, 255, 295, then monitor for audible, gesture, and/or button press response(s) AS, GS, BS.

Upon detecting a “spell” response, at least one of controller(s) and components 140, 145, 195, 200, 215, 255, 295, may acknowledge a listen more and recite and/or display a prompt such as “Spell mode, listening,” and then monitor for an audible spelled correction and/or a visually displayed alphabet or keyboard or similar representation that enables gesture and/or a software button press for each spelled letter of the correction. In another example, if an audible, gesture, and/or button press “select” and/or “recommend” response is detected by way of signals AS, BS, GS, one or more of controller(s) 145, 195, 200, 255, 295, are also configured to search repository 180 for possible matches to ERRs of RWs, and to audibly recite and/or visually display a list of recommended corrections CORRs, which can be audibly selected and/or selected by a button press, and/or combinations thereof.

In response to receiving an audible, gesture, and/or textually spelled correction CORR or corrections CORRs, and/or selected recommended CORRs, at least one of controller(s) and components 140, 145, 195, 200, 215, 255, 295, is/are configured to generate a corrected electronic sequence CES of recognized words RWs. The CES incorporates and is generated according to the audible and/or textual CORRs. One or more of HFC(s) 195 and/or other controller(s) and components 140, 145, 200, 215, 255, 295, are further configured to generate one or more and/or at least one control command(s) from the corrected sequence CES.

The control command(s) enable control of an internal and/or external system or device VSC 140, VCS 145, PNDs 275, VNDs 280, NMDs 285, AXDs 285, and others. Such control is in turn further enabled by communication of such control commands to at least one and/or one or more vehicle communication unit(s) that are integrated with and/or coupled to controller(s) and components 140, 145, 195, 200, 215, 255, 295, directly and/or via communications units ATs, USBs 230, NFCs 235, WRTs 240, CMTs 245, AXDs 290.

Such control command(s) include for purposes of illustration but not limitation, and/or may be part of, embedded with, and/or generated as RPCs, OS 185, CS 190, and other types of control commands. At least one and/or one or more of HFCs 195 and controller(s) and components 140, 145, 195, 200, 215, 255, 295, in additional exemplary but not limiting variations of the disclosure, are further modified to respond to CESs, and to generate and communicate the control command(s) to command, control, and/or enable one or more of phone calls, text messages, navigation actions, infotainment control, and other similar types of control commands. These control commands are communicated by the controller(s) to the vehicle communication unit(s) and other internal and external devices as described elsewhere herein.

Other exemplary adaptations of the disclosure and vehicle(s) 100, HFCs 195 and controller(s) and components 140, 145, 195, 200, 215, 255, 295, include modifications that enable responding to CESs, to generate and communicate the control command(s) as at least one and/or one or more of: commands that control vehicle lighting, cabin seat adjustments, climate controls, and/or vehicle control conditions such as key on, key off, trunk latch open, door lock and unlock, window open and close, garage door actuator, autonomous parking, autonomous driving commands, V2V, I2V, V2I, and home automation commands that can include security system actuation, home lighting controls, and/or home door lock actuation, parking garage and community entry authentication and gate systems, among other conditions, commands, and controls. Additional such control commands include for further examples: vehicle fuel, electrical, and propulsion system status inquiry(ies) and configuration commands, and other vehicle control and inquiry commands.

In response to CESs, HFCs 195 and controller(s) and components 140, 145, 195, 200, 215, 255, 295, are further configured to store one or more learned correction(s) LCs to an autocorrect repository, which repository can be part of repository 180 or another internal storage component 205, 210, and/or external storage device 275, 280, 285, 290. The autocorrect repository of such accumulated LCs corrections, is utilized to generate one or more of RWs as new audible commands are detected by HFCs 195 and controller(s) and components 140, 145, 195, 200, 215, 255, 295. Such LCs of the autocorrect repository are also utilized to generate correction recommendations CORRs for prospective identified errors ERRs.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A vehicle, comprising:
a hands free controller configured to:
in response to audio signals received from a voice processor,
communicate an electronic sequence of recognized words from the audio signals,
receive a selection of a part of the electronic sequence including an error in the recognized words,
receive from the voice processor an audible correction to replace the error, and
generate, and communicate to a vehicle communication unit, a control command from a corrected electronic sequence generated according to the audible correction.

2. The vehicle according to claim 1, comprising:
the hands free controller further configured to, in response to the corrected electronic sequence, generate and store a learned correction to an autocorrect repository.

3. The vehicle according to claim 2, comprising:
the hands free controller further configured to detect and receive the error with one or more of an audible and electronic signal that includes at least one of a recommend command, which retrieves recommended corrections from the autocorrect repository, and a spell command.

4. The vehicle according to claim 1, comprising:
the hands free controller further configured to communicate the electronic sequence of recognized words as at least one of audio and text, to one or more of the voice processor and a vehicle display.

5. The vehicle according to claim 1, comprising:
the hands free controller further configured to detect the error from one or more of a touch signal from a vehicle display, an audio signal from the voice processor, and a selection signal from a switch of a vehicle instrument cluster, which signals interactively identify the error on the vehicle display.

6. The vehicle according to claim 1, comprising:
the hands free controller, coupled to an image sensor, further configured to detect the error from one or more gestures detected by the image sensor.

7. The vehicle according to claim 1, comprising:
the hands free controller further configured to detect the error, in response to the electronic sequence of recognized words, from at least one of the voice processor and a button of a vehicle instrument cluster.

8. The vehicle according to claim 1, comprising:
the hands free controller further configured to, in response to the corrected electronic sequence, generate the control command as one or more of phone call, text message, navigation, and infotainment commands that are communicated to the vehicle communications unit.

9. The vehicle according to claim 1, comprising:
the hands free controller further configured to, in response to the corrected electronic sequence, generate the control command as one or more of vehicle lighting, seat adjustment, climate control, key on, key off, trunk latch, door lock, door opener, garage actuator, autonomous parking, and autonomous driving commands, which are communicated to the vehicle communications unit.

10. The vehicle according to claim 1, comprising:
the hands free controller further configured to, in response to the corrected electronic sequence, generate the control command as one or more of vehicle fuel, electrical, and propulsion system status inquiry and configuration commands, which are communicated to the vehicle communications unit.

11. A vehicle, comprising:
a hands free controller configured to:
in response to audio signals received from a voice processor,
communicate recognized words from the audio signals,
receive a selection of a part of the recognized words including an error,
receive from the voice processor an audible correction to replace the error,
generate, and communicate to a vehicle communication unit, a control command from a corrected electronic sequence generated according to the correction, and generate and store the correction to an autocorrect repository.

12. The vehicle according to claim 11, comprising:
the hands free controller further configured to detect and receive the error with one or more of a spell command, and a recommend command that retrieves recommended corrections from the autocorrect repository.

13. The vehicle according to claim 11, comprising:
the hands free controller further configured to:
communicate the recognized words to one or more of the voice processor and a vehicle display, and
detect and receive the error interactively by at least one of audible and selection signals.

14. The vehicle according to claim 13, comprising:
the at least one audible signal is received from the voice processor and the at least one selection signal is received from one or more of a touch signal from the vehicle display and a button of a vehicle instrument cluster.

15. The vehicle according to claim 13, comprising:
the hands free controller, coupled to an image sensor, further configured to receive the selection signals from one or more gestures detected by the image sensor.

16. A method of controlling a vehicle, comprising:
by a hands free controller:
in response to audio signals received from a voice processor,
communicating recognized words from the audio signals;
receiving a selection of a part of recognized words including an error;
receiving from the voice processor an audible correction to replace the error; and
generating, and communicating to a vehicle communication unit, a control command from a corrected electronic sequence generated according to the correction.

17. The method according to claim 16, comprising:
by the hands free controller, coupled to an autocorrect repository:
generating and storing the correction to the autocorrect repository; and
detecting and receiving the error with one or more of: a spell command, and a select recommendation command that retrieves recommended corrections from the autocorrect repository.

18. The method according to claim 16, comprising:
by the hands free controller, coupled to an autocorrect repository:
communicating the recognized words to one or more of the voice processor and a vehicle display; and
detecting and receiving the error interactively by at least one of audible and selection signals.

19. The method according to claim 18, comprising:
by the hands free controller:
receiving the at least one audible signal from the voice processor; and
receiving the at least one selection signal from one or more of a touch signal from the vehicle display and a button of a vehicle instrument cluster.

20. The method according to claim 18, comprising:
by the hands free controller, coupled to an image sensor:
detecting by the image sensor, one or more gestures representing selection of the error; and
generating the selection signal to the one or more gestures.
